(19) United States
(12) Patent Application Publication
(10) Pub. No.: US 2026/0127445 A1
(43) Pub. Date: May 7, 2026

(54) AI-DRIVEN ENERGY OPTIMIZATION ARCHITECTURE

(71) Applicant: Dell Products L.P., Round Rock, TX (US)

(72) Inventor: Mahuya Ghosh, Hyderabad (IN)

(73) Assignee: Dell Products L.P., Round Rock, TX (US)

(21) Appl. No.: 18/939,795

(22) Filed: Nov. 7, 2024

(51) Int. Cl. G06N 3/098

(52) U.S. Cl. CPC G06N 3/098

(57) ABSTRACT

Methods and systems for intelligently managing user interactions and experiences with content delivery networks (CDNs)to promote energy efficiency, user privacy, and security are provided. A CDN collects data relating to one or more user’s interactions with an application. Machine learning (M/L) models analyze and train on the usage data to predict user behavior patterns, application performance trends and device metrics to reduce energy consumption. The predicted outputs may be used to generate a real-time adaptive user interaction policy configured to enable proactive system energy consumption savings and optimizations.

### BACKGROUND

The proliferation of the Internet and connected computing networks has greatly expanded the amount of data produced and consumed through various online platforms and services, including business-to-business (B2B) and business-to-consumer (B2C) environments. The increased presence and activity of online services significantly influences energy consumption demands and patterns, leading to a larger carbon footprint associated with such digital activities. While enhancing user experience through performance and personalization has been an industry focus, few efforts have been made to address the environmental consequences of such practices. Further, the centralization of data and user information, for the sake of efficiency and convenience, raises privacy and security concerns. There is a lack in the pursuit of sustainable digital service design and delivery that maintains user privacy and security.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include training a plurality of machine learning (M/L) models to predict one or more energy-saving policies using a modeling dataset comprising a plurality of training samples. Each training sample may be generated from a corpus of historical interaction data. Each training sample of the plurality of training samples may adjust weights in the plurality of M/L models. Training the plurality of M/L models may include inputting different portions of the training dataset and comparing predictions of customer actions with target values of the training samples to adjust weights in the plurality of M/L models. Usage data may be received from an application. A plurality of feature vectors may be generated from the usage data. One or more of the plurality of feature vectors may be input into one of the plurality of M/L models to predict one or more energy-saving policies. A user interaction policy may be generated based on the one or more energy-saving policies.

The method may include, alone or in combination, one or more of the following features. The plurality of M/L models may include at least a federated learning model and an unsupervised learning model. The plurality of M/L models may include at least, a hybrid federated learning model, a gradient boosting machine (GBM) model, a meta-learning model, a convolutional neural network (CNN), a recurrent neural network (RNN), a Differential Privacy model, and a Secure Multi-party computation model. The usage data may include at least one of user interaction data, contextual data, and system data. The user interaction data may include at least one of device usage metrics, content preferences, and user feedback. The contextual data may include at least one of an environmental condition and a temporal dynamic. The system data may include multi-device synchronization data. The one or more energy-saving policies may include one or more of a display and interface adjustment, a content delivery optimization, a data management and processing optimization, a device and system level optimization, a services and integration optimization. An energy savings report may be generated based on the user interaction policy.

According to another aspect, a system may include a memory and at least one processor that is operatively coupled to the memory. The at least one processor may be configured to perform the operations of training a plurality of M/L models to predict one or more energy-saving policies using a modeling dataset comprising a plurality of training samples. Each training sample may be generated from a corpus of historical interaction data. Each training sample of the plurality of training samples may adjust weights in the plurality of M/L models. Training the plurality of M/L models may include inputting different portions of the training dataset and comparing predictions of customer actions with target values of the training samples to adjust weights in the plurality of M/L models. Usage data may be received from an application. A plurality of feature vectors may be generated from the usage data. One or more of the plurality of feature vectors may be input into one of the plurality of M/L models to predict one or more energy-saving policies. A user interaction policy may be generated based on the one or more energy-saving policies.

The system may include, alone or in combination, one or more of the following features. The plurality of M/L models may include at least a federated learning model and an unsupervised learning model. The plurality of M/L models may include at least, a hybrid federated learning model, a gradient boosting machine (GBM) model, a meta-learning model, a convolutional neural network (CNN), a recurrent neural network (RNN), a Differential Privacy model, and a Secure Multi-party computation model. The usage data may include at least one of user interaction data, contextual data, and system data. The user interaction data may include at least one of device usage metrics, content preferences, and user feedback. The contextual data may include at least one of an environmental condition and a temporal dynamic. The system data may include multi-device synchronization data. The one or more energy-saving policies may include one or more of a display and interface adjustment, a content delivery optimization, a data management and processing optimization, a device and system level optimization, a services and integration optimization. An energy savings report may be generated based on the user interaction policy.

According to another aspect, a non-transitory computer-readable medium may store one or more processor-executable instructions, which when executed by at least one processor cause the at least one processor to perform the operations of training a plurality of M/L models to predict one or more energy-saving policies using a modeling dataset comprising a plurality of training samples. Each training sample may be generated from a corpus of historical interaction data. Each training sample of the plurality of training samples may adjust weights in the plurality of M/L models. Training the plurality of M/L models may include inputting different portions of the training dataset and comparing predictions of customer actions with target values of the training samples to adjust weights in the plurality of M/L models. Usage data may be received from an application. A plurality of feature vectors may be generated from the usage data. One or more of the plurality of feature vectors may be input into one of the plurality of M/L models to predict one or more energy-saving policies. A user interaction policy may be generated based on the one or more energy-saving policies.

The non-transitory computer-readable medium may further include, alone or in combination, at least, a hybrid federated learning model, a gradient boosting machine (GBM) model, a meta-learning model, a convolutional neural network (CNN), a recurrent neural network (RNN), a Differential Privacy model, and Secure Multi-party computation model.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a storage system, according to one or more aspects of the present disclosure;

FIG. 1B is a diagram of an example of a storage processor, according to one or more aspects of the present disclosure;

FIG. 2 is an example of a flow diagram of an intelligent energy optimization architecture strategy, according to one or more aspects of the present disclosure;

FIG. 3 is a block diagram of an intelligent energy-efficient architecture, according to one or more aspects of the present disclosure;

FIG. 4 is a flow diagram mapping system inputs to machine learning models and their outputs, according to one or more aspects of the present disclosure;

FIG. 5A is an exemplary user interface, according to one or more aspects of the present disclosure;

FIG. 5B is an alternative user interface, according to one or more aspects of the present disclosure;

FIG. 6A is a predictive energy management interface, according to one or more aspects of the present disclosure;

FIG. 6B is an alternative predictive energy management interface, according to one or more aspects of the present disclosure;

FIG. 6C is another alternative predictive energy management interface, according to one or more aspects of the present disclosure; and

FIG. 7 is a diagram of an example of a computing device, according to aspects of the disclosure.

### DETAILED DESCRIPTION

Aspects of the present disclosure include methods and systems for intelligently managing user interactions and experiences with content delivery networks (CDNs)to promote energy efficiency, user privacy, and security. In a business-to-business (B2B), business-to-consumer (B2C) or other consumer-facing application architecture, a CDN may collect data relating to one or more user’s interactions with an application. Machine learning (M/L) models analyze and train on the usage data to predict user behavior patterns, application performance trends and device metrics to reduce energy consumption. The predicted outputs may be used to generate a real-time adaptive user interaction policy configured to enable proactive system savings and optimizations. The architectures described herein may combine the power of an array of machine-learning models, including federated learning and unsupervised artificial intelligence (AI) and user-experience optimization techniques to create an intelligent CDN that adapts to user demands and network conditions while reducing energy consumption. By leveraging distributed knowledge and predictive analytics, the disclosed methods and systems may optimize content delivery, reduce energy usage, and improve the overall user experience.

Aspects of the present disclosure provide concepts, techniques, and structures for leveraging federated and unsupervised machine learning to pioneer a green, eco-friendly approach to optimizing user experiences and content delivery. Aspects of the disclosure include minimizing energy usage and carbon emissions through intelligent, data-driven optimizations of user interfaces, content delivery, and interaction patterns, while limiting the environmental footprint. Additional aspects may enhance privacy and reduce energy costs by processing data on distributed devices. As such, the systems and methods described herein may preserve user privacy as well as reduce the energy expenses linked with centralizing data.

In another aspect, the concepts, techniques and structures described herein provide for the ability to learn and adapt continuously, ensuring that user experiences are constantly improving in an energy-efficient manner. Accordingly, sustainable, user-centric digital services that respect both the planet and the privacy of individuals may be developed.

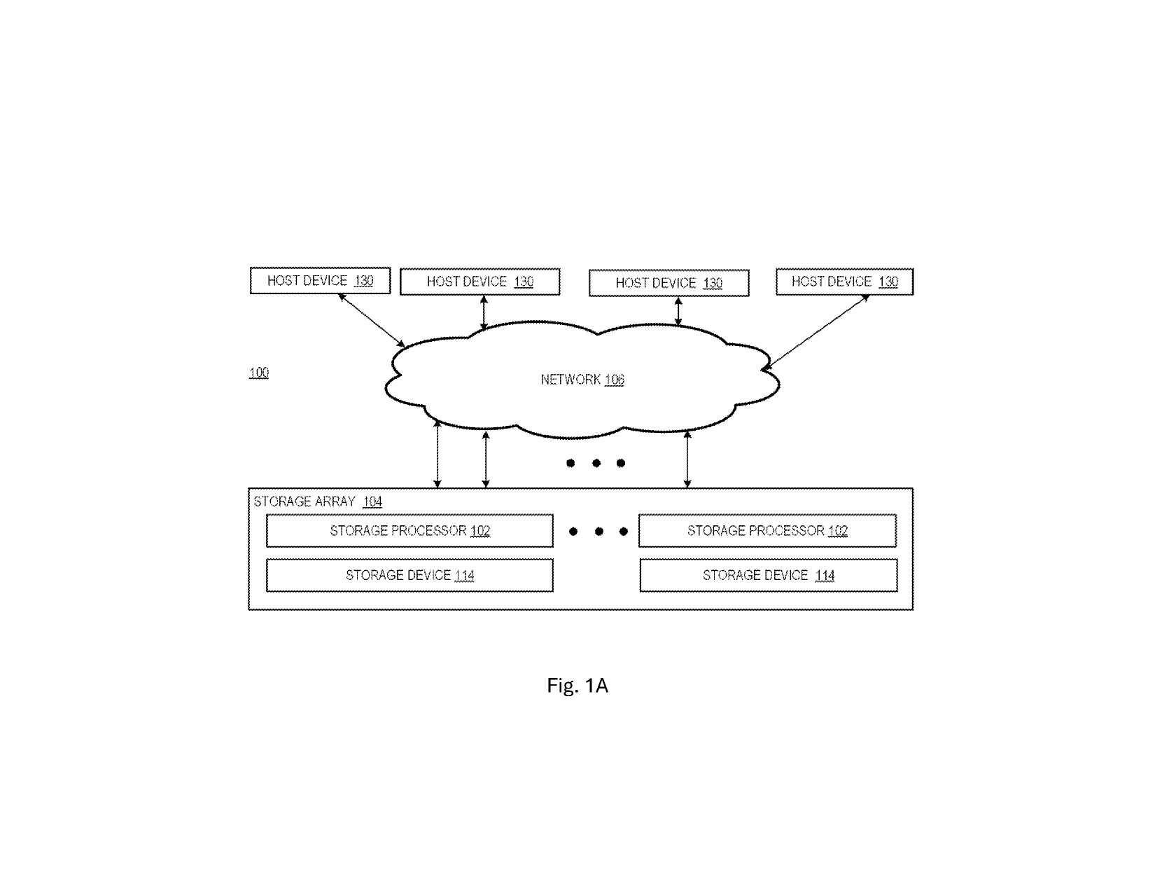

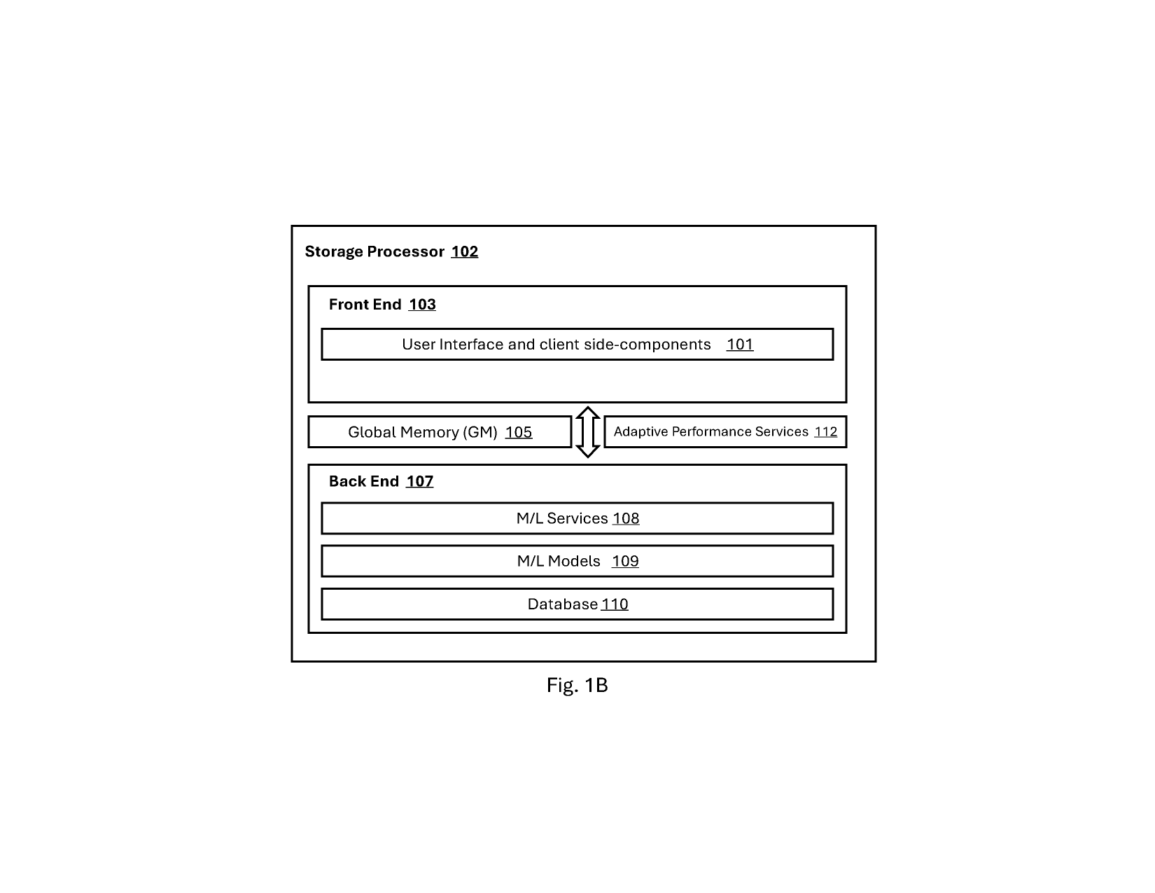

FIG. 1A is a diagram of an example of a CDN system 100, according to aspects of the disclosure. As illustrated, the CDN system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include or be arranged with one or more storage processors 102 and a plurality of non-volatile memory storage devices 114. Each of the storage processors 102 may be configured to receive Input/Output (I/O) requests from host devices 130 and execute the received I/O requests by reading and/or writing data to storage devices 114. According to one aspect, the storage array 104 may include or define one or more edge nodes. Each of the host devices 130 may include a desktop computer, a laptop, a smartphone, an internet-of-things (IoT) device, and/or any other suitable type of computing device.

According to one aspect, the CDN system may include a B2B, B2C, architecture or other consumer-facing application. Interactions between users’ host devices 130 and storage arrays 104 may include a micro-frontend (MFE)-based architecture and/or a commercial cloud platform, such as Pivotal Cloud Foundry (PCF), or the like.

FIG. 1B is a diagram of an example of a storage processor 102, according to aspects of the disclosure. As illustrated, the storage processor 102 may include a front end module 103 featuring a user interface and client-side components 101. The front end 103 may be responsible for caching in global memory (GM) 105 data associated with incoming requests. Additionally, the front end 103 may handle or process administrative settings to configure cache settings, monitor cache performance and view cache and system analytics. The front end 103 may further process and/or generate real-time system notifications and alerts for cache-related events. A back end module 107 may include, among other functionalities, machine learning (M/L) services 108, M/L models 109 and a database 110. According to one aspect, the M/L models 108 may include a federated learning model and a reinforcement learning model, described in further detail below.

The back end 107 may be responsible for destaging the data from GM 105 into the storage devices 114 (FIG. 1A). In addition, the back end 107 may be responsible for loading, into the GM 105, data associated with incoming read requests, and the front end 103 may be responsible for returning the cached data to the senders of the read requests. The front end 103 and back end 107 may be implemented as various services (or kernel components) of the storage processors 102.

Adaptive performance services 112 may include a services layer to provide application programming interfaces (APIs) to enable seamless integration of user interaction policy with front end 103 applications and systems, such as a B2B, B2C or other commercial platform.

According to aspects of the disclosure, described in detail below, the M/L services 108, M/L models 109 and database 110 of the back end module 107 may operate in conjunction with the adaptive performance services 112 to provide one or more user interaction policies configured to proactively conserve energy usage and optimize both system and content delivery, thereby enhancing system performance in a tangible and practical manner. Each storage processor 102, or CDN node, may incorporate machine learning capabilities, including federated and unsupervised learning, allowing them to collaborate and collectively learn from user interactions and content popularity across different regions. The aggregation and analysis of the distributed knowledge may allow the storage processors 102 to dynamically adjust user interactions and policies adapted to those interactions to optimize and make more energy-efficient content delivery, while improving user experiences, privacy and security.

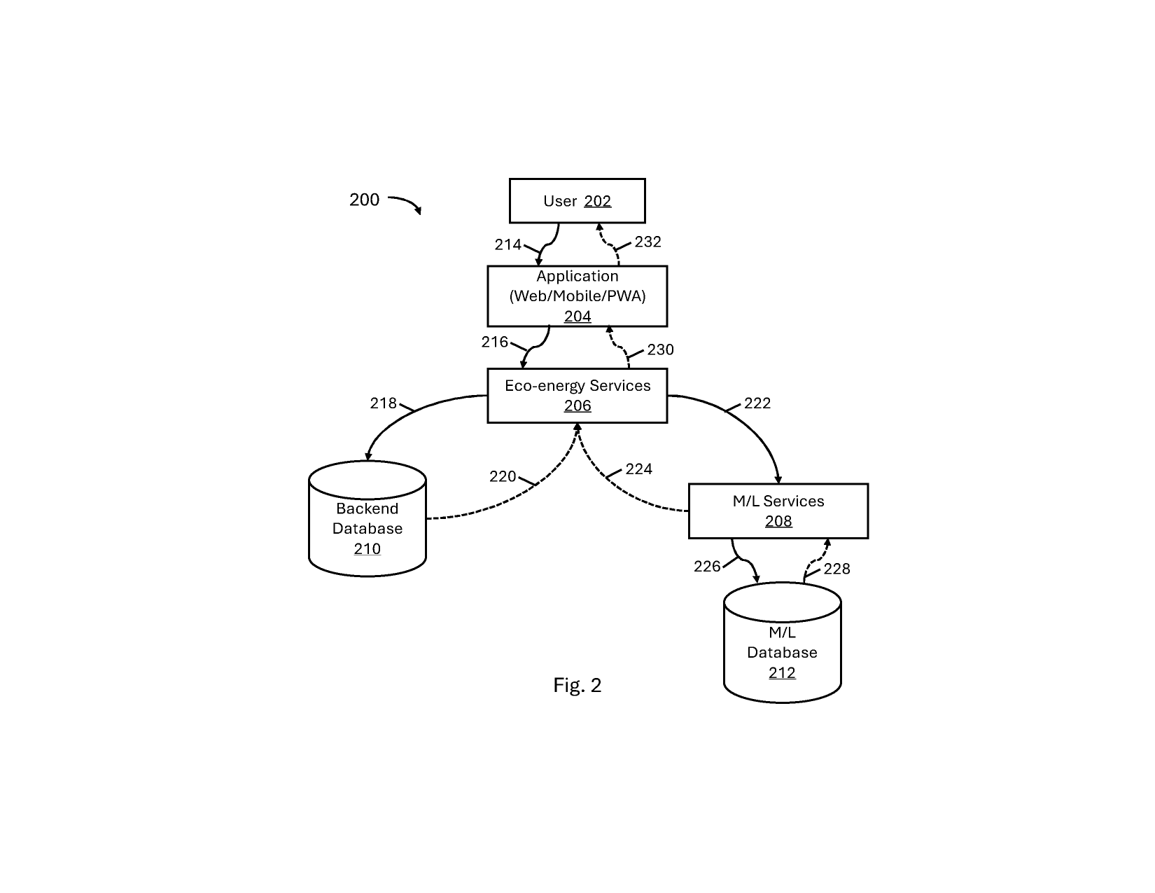

FIG. 2 is a flow diagram of an intelligent energy optimization architecture strategy 200, according to one or more aspects of the present disclosure. The strategy 200 may be structured around, in one example, four building blocks: one or more users 202, one or more applications 204, eco-energy services 206, and M/L services 208. Each block, as described herein, may serve a role in the data flow and decision-making process for optimizing energy efficiency and user experience in a CDN. According to one aspect, the detailed steps and loops described may ensure continuous adaptation and optimization based on real-time data and insights.

According to one aspect, a first step, denoted by arrow 214, may include a user 202 engaging with an application 204 generating data and device usage metrics. According to one aspect, the application 204 may include or be a mobile application, a web application, a progressive web application (PWA), or the like. Accordingly, as described herein, the concepts, structures, and techniques may be configured with any type of digital device. The application 204 may authenticate the user, initiate a session or interaction, and begin collecting data on the user’s interactions with the application. The application 204 may further collect device metrics measured or observed during the user’s interactions.

In another step, denoted by arrow 216, the application 204 may forward the collected data to the eco-energy services 206. The collected data may undergo advanced processing and analysis, as described herein, by the eco-energy services 206. The eco-energy services 206 may implement a continuous data collection loop, denoted by arrows 218, 220, in which user data and device insight (e.g. device metrics) may be aggregated and stored in a decentralized manner. The eco-energy services may, according to one aspect, prepare the collected data for processing by the M/L services 208. The collected and processed data may be temporarily stored in a backend database 210. The backend database 210 may be the same or similar to the backend database 110 shown in FIG. 1B. The continuous collection, processing and storage of data may provide a rich and robust dataset for analysis and user interaction policy generation, as described herein.

According to one aspect, the continuous data collection loop may serve to build and store a corpus of historical interaction data. In one aspect, interaction data may include user interaction data, device usage metrics, content preferences, environmental conditions, temporal dynamics, cross-device synchronization data, user feedback and the like, collected over time from one or more application users.

According to one aspect, the eco-energy services 206 and the M/L services 208 may form or implement a dynamic strategy determination loop, denoted by arrows 222, 224. The dynamic strategy determination loop may include the eco-energy services 206 may send one or more requests to the M/L services 208, specifying a need for processing data to derive energy efficiency strategies and optimize content delivery. The dynamic strategy determination loop may feature the ability to dynamically adjust the operational user interaction strategies based on evolving or changing information (e.g., insights and conditions). Accordingly, the generated optimizations and strategies may remain effective over time, responding proactively to recent user and device data.

According to one aspect, the M/L services 208 may form or implement a training and updating loop, denoted by arrows 226, 228, with a M/L database 212. The M/L database 212 may store the exemplary models described herein along with training data and the like. The various exemplary models described herein may be updated and retrained periodically upon receiving new data. The data updates and updated training data may be stored in the M/L database 212.

According to one aspect, the M/L services may be configured to generate (or “create”) a modeling dataset for use in generating (e.g., training, testing, etc.) one or more M/L models to generate one or more outputs as described herein. M/L services 208 can retrieve from M/L database 212 a corpus of historical lead conversion data from which to generate the modeling dataset. In one embodiment, one, two, or more years of historical lead conversion data can be retrieved from which to create the modeling dataset. The amount of historical lead conversion data to retrieve and use to create the modeling dataset may be configurable by the organization.

To generate a modeling dataset, M/L services 208 may preprocess the retrieved corpus of historical lead conversion data to be in a form that is suitable for training and testing the one or more M/L models. In one embodiment, M/L services 208 may utilize natural language processing (NLP) algorithms and techniques to preprocess the retrieved lead conversion data. For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stop words removal, stemming, and/or lemmatization.

The data preprocessing may also include placing the data into a tabular format. In the table, the structured columns represent the features (also called “variables”) and each row represents an observation or instance (e.g., a historical lead). Thus, each column in the table shows a different feature of the instance. The data preprocessing may also include placing the data (information) in the table into a format that is suitable for training a model (e.g., placing into a format that is suitable for a random forest algorithm or other suitable learning algorithm to learn from to generate (or “build”) the one or more M/L models). For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding or other suitable encoding methods.

The data preprocessing may also include null data handling (e.g., the handling of missing values in the table). According to one embodiment, null or missing values in a column (a feature) may be replaced by a means of the other values in that column. For example, mean imputation may be performed using a mean imputation technique such as that provided by Scikit-learn (Sklearn). According to alternative embodiments, observations in the table with null or missing values in a column may be replaced by a mode or median value of the values in that column or removed from the table.

The data preprocessing may also include feature selection and/or data engineering to determine or identify the relevant or important features from the noisy data. The relevant/important features are the features that are more correlated with the thing being predicted by the trained model (e.g., a likelihood of a lead conversion). A variety of feature engineering techniques, such as exploratory data analysis (EDA) and/or bivariate data analysis with multivariate-variate plots and/or correlation heatmaps and diagrams, among others, may be used to determine the relevant features. The relevant features are the features that are more correlated with the thing being predicted by the trained model. For example, for a particular historical lead, the relevant features may include important features from the lead data such as customer/account, lead contact, lead owner, lead source (e.g., partner/contact, web, unknown, etc.), campaign type, product focus, solution, region, and language, among others.

The data preprocessing can include adding an informative label to each instance in the modeling dataset. As explained above, each instance in the modeling dataset includes interaction data. A label is added to each instance in the modeling dataset. The label added to each instance, is a representation of what class of objects the instance in the modeling dataset belongs to and helps a machine learning model learn to identify that particular class when encountered in data without a label.

Each instance in the table may represent a training/testing sample (i.e., an instance of a training/testing sample) in the modeling dataset and each column may be a relevant feature of the training/testing sample. As previously described, each training/testing sample may correspond to historical interaction data. In a training/testing sample, the relevant features are the independent variables and the thing being predicted is the dependent variable (e.g., label). In some embodiments, the individual training/testing samples may be used to generate a feature vector, which is a multi-dimensional vector of elements or components that represent the features in a training/testing sample. In such embodiments, the generated feature vectors may be used for training or testing the one or more M/L models using supervised or unsupervised learning to make a prediction.

In some embodiments, M/L services 208 may reduce the number of features in the modeling dataset. For example, since the modeling dataset is being generated from the corpus of historical lead conversion data, the number of features (or input variables) in the dataset may be very large. The large number of input features can result in poor performance for machine learning algorithms. For example, in one embodiment, M/L services 208 can utilize dimensionality reduction techniques, such as principal component analysis (PCA), to reduce the dimension of the modeling dataset (e.g., reduce the number of features in the dataset), hence improving the model's accuracy and performance.

In some aspects, M/L services 208 can generate the modeling dataset on a continuous or periodic basis (e.g., according to a predetermined schedule). For example, M/L services 208 can generate the modeling dataset according to a preconfigured schedule. Additionally, or alternatively, M/L services 208 can generate the modeling dataset in response to an input. For example, a user may issue a request to generate a modeling dataset. In some cases, the request may indicate an amount of historical interaction data to use in generating the modeling dataset. In response, M/L services 208 can retrieve the historical interaction data for generating the modeling dataset from M/L database 212 and generate the modeling dataset using the retrieved historical lead conversion data. M/L services 208 can store the generated modeling dataset within M/L database 212, where it can subsequently be retrieved and used (e.g., retrieved and used to build one or more M/L models for predicting a likelihood of a lead conversion).

According to one or more aspects, requests from the eco-energy services, including requests for user interaction policies and content delivery strategies, may be transmitted to the M/L services 208 and processed through a combination of certain M/L models and overarching strategies. According to one aspect, a hybrid federated learning architecture may be implemented to blend federated averaging techniques (FedAvg) and Federated Stochastic Gradient Descent techniques (FedSGD) to train models across one or more distributed datasets without compromising user privacy. According to one aspect, the hybrid federated learning may be tailored to handle diverse data sources efficiently, adapting to varying data volumes and characteristics.

The M/L services 212 may also include or implement energy-efficiency predictive models to employ gradient boosting machines (GBM) for predicting and optimizing energy consumption patterns. According to one aspect, GBMs may be chosen for their effectiveness in handling tabular data and a superior performance in predictive accuracy for complex, non-linear problems.

The M/L services 212 may also include or implement model personalization techniques. According to one aspect, the M/L services 212 may apply meta-learning and client clustering to adapt models for personalized user experiences. Doing so may address a potential challenge of using Non-Independent and Identically Distributed (non-IID) data in federated learning environments. The use of meta-learning and client clustering may ensure models remain effective even when data distributions vary significantly across devices.

The M/L services 212 may also include or implement advanced neural network architectures. According to one aspect, the M/L service 212 may implement specialized neural networks, such as Convolutional Neural Networks (CNNs) for image-based data and Recurrent Neural Networks (RNNs) for sequential data, to capture complex patterns and dependencies in the data. These architectures may be selected for their ability to process high-dimensional data and provide insights into user behavior and device usage.

Privacy-preserving techniques may be utilized to incorporate methods including Differential Privacy and Secure Multi-party Computation in the training process to protect user data. Such techniques may ensure that the system learns from distributed data sources without exposing sensitive information, maintaining user trust and regulatory compliance.

According to one aspect, the insights and model updates generated by the processes of the M/L services may be stored in the M/L Database 212, readily accessible for informing the eco-energy services decisions on system optimizations and content delivery.

Armed with the machine learning models, techniques and structures provided by the M/L services 212, the eco-energy services 206 may request and receive insights, for example, predictions, user interaction policies, content delivery strategies, or the like. The insights may be stored in the backend database 210. According to one aspect, the insights generated and provided by the M/L services may inform decision making processed in the eco-energy services 206 regarding user experiences and interface adjustments, content delivery, and device responsiveness to implement and maintain energy efficient strategies that are data-driven and effective.

According to one aspect, the eco-energy services 206 may formulate user interface and user experience adjustments and optimizations based on the insights generated and provided by the M/L services. The adjustments and optimizations may be formulated to enhance energy efficiency and the user experience with the application. According to one aspect, the eco-energy services 206 may focus or center it suggested adjustments and optimizations according to a number of metrics, including for example, energy consumption per task. [[The metrics may be expressed, as described herein, in terms of percentages (e.g., compared to averages or prior tasks), energy units saved (e.g., kilowatt hours kWh)), or in a monetary amount indicating the amount saved through implementation of the adjustments and optimizations.

According to one aspect, the application 204 may receive the suggested optimizations and adjustments, denoted by arrow 230 from the eco-energy services 206. The application 204 may implement the suggested adjustments and optimizations to improve the user interface or user experience, denoted by arrow 232.

According to one aspect, the outcomes of these implementations, together with any user feedback, may be stored in the backend database 210 which may facilitate future analysis and continuous improvement. Accordingly, a feedback loop may be created that drives the system towards greater and improved efficiency and user satisfaction beyond what a system designer/operator may accomplish individually and without the use of the described eco-energy services.

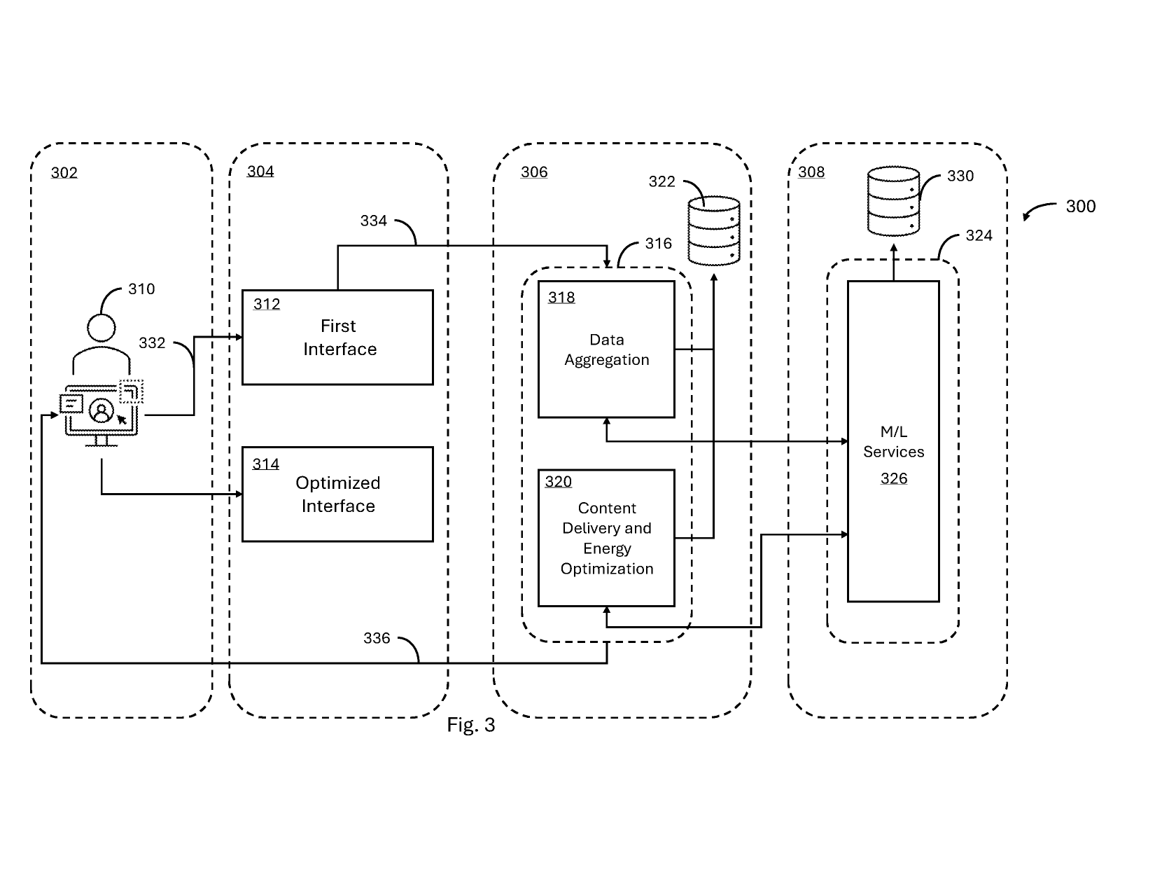

FIG. 3 is a block diagram of an intelligent energy optimization system 300, according to one or more aspects of the present disclosure. The system 300 may include a user space 302, a front end space 304, an adaptive performance space 306 and a M/L space 308. The user space 302 may include or be the same or similar to the user module 202 shown in FIG. 2. The adaptive performance space 306 may include or be the same or similar to the eco-energy services 206 of FIG. 2 and the M/L space 308 may include or be the same or similar to the M/L services 208 and M/L database 212 of FIG. 2. As shown in FIG. 3, each of the conceptual spaces may be involved in intelligently processing user interactions, experiences and content delivery for consumer-facing applications, or the like.

According to one aspect, the user space may include a user computing device 310, such as a host device 130 (FIG. 1A), configured to access and interact with an application, over a network, to engage in a transaction, commercial or otherwise. The application may be the same or similar to the application 204 shown and described in FIG. 2. The user computing device may invoke the application which may be provided through the front end space 304. The front end space 304 may include the applications with which the user may interact. For example, a first interface 312 may be provided to the user, via a web browser, widget, mobile application, or other application, with which the user may interact. The user interactions with the first interface 312 may include clickstream data and behavior patterns, as well as device metrics, including operation statistics, measurements, or the like, related to the device through which the user is interacting with the system. As the user interacts with the system 300, the user interaction data and the device metrics, along with other application-level metrics, may be input to a first loop 316 in the adaptive performance space 306. The first loop may be a continuous data collection loop, as previously described. The first loop 316 may include a decentralized data aggregation module 318 and a content delivery and energy optimization module 320.

According to one aspect, the decentralized data aggregation module 318 and the content delivery and energy optimization module 320 may include APIs to enable integration of the adaptive performance functionalities generated in the M/L space 308. The front end space 304 may then be able to render the content and complete the user’s actions in an observable fashion (i.e., improved application performance) through the interface, shown here as an optimized interface 314. For example, the user may begin interacting with the application, shown by arrow 332. The actions requested by the user, for example in the form of interactions with the application, may be processed and aggregated according to the functionalities of the adaptive performance space 306, shown by arrow 334. After the requests are processed according to user interaction policy, content may be rendered and the user’s requested actions may be performed, shown by arrow 336. One skilled in the art will recognize that the optimized interface 314 may be similar to the first interface 314, albeit reflecting the energy-saving user interaction policy as determined by the eco-energy services and the adaptive performance space 306.

As described herein, the decentralized data aggregation module 318 may collect the user interactions and metadata in a decentralized manner. Such data may be stored in a first database 322, which may be the same or similar to the backend database 210 of FIG. 2. The decentralized data aggregation module 318 may rely on the services of the M/L space 308. The M/L space 308 may include a second loop 324, similar to the training and updating loop previously described, including M/L services 326 and a M/L database 330. The M/L database 330 may be similar or the same as the M/L database 212 of FIG. 2. The M/L database 330 may be part of the M/L space 308 as a mechanism for storing the M/L models and associated data. The decentralized data aggregation module 318 may call the M/L services 326, including federated and unsupervised learning models, and its machine learning processes to analyze usage patterns and provide intelligent recommendations for energy-saving strategies in a decentralized and secure manner.

In one aspect, the system 300 may be integrated with similar systems and devices to integrate with, or form and ecosystem for comprehensive energy savings. Accordingly, the system may coordinate with the broader ecosystem of devices, including smart power-efficient geolocation services, for overall energy optimization. In such a manner, interaction data, user interaction policies, insights, predictions and recommendations may be leveraged across the ecosystem for broader application and energy saving benefits.

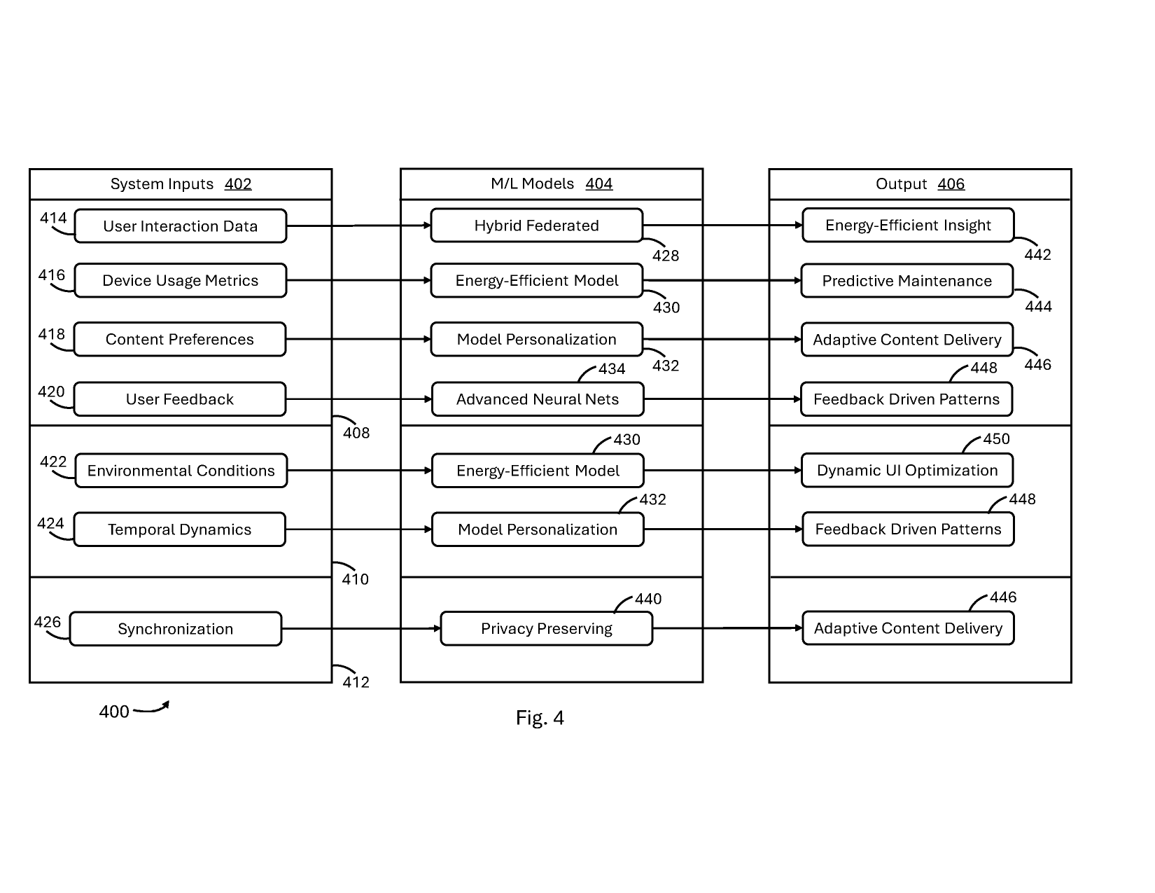

According to one aspect, the M/L services may use a number of varying learning models to analyze and process user inputs and device metrics to then output one or more components of a user interaction policy for implementation. FIG. 4 is a flow diagram 400 mapping system inputs 402 to the M/L services and models 404 to generate a number of outputs 406.

The system inputs 402, according to one or more aspects may be categorized according to user data 408, contextual data 410, and system data 412. One skilled in the art will recognize that the categorizations of the inputs, as described herein, may be conceptual and are not intended to limit the source or characterization of the data. For example, the user data 408 may include user interaction data 414, including information detailing how users interact with applications, including click patterns, navigation paths, usage frequency, and the like. The user data 408 may also include device metrics 416, including data detailing device operation that may impact energy consumption, such as app usage duration, background processes, battery levels, and the like. Such data may also capture more granular data on energy consumption patterns for each application and process, including foreground and background energy use. Content preferences 418 may also be used as inputs. Such data may include user preferences inferred from content consumption patterns, including, for example, favored products, videos, services or the like. The user data 408 may also include user feedback 420 including, for example, direct feedback from a user on user interface and user experience preferences related to energy efficiency and personalization. According to one aspect, as described herein, user feedback data, and other personal data collection may be collected in a privacy-preserving manner.

Contextual data 410, according to one aspect, may include environmental conditions 422 and temporal dynamics 424. Environmental conditions 422 may include for example external factors affecting device use, such as network type (e.g., WiFi, 4G), battery charging patterns and the like. This data may also include ambient temperature, device temperature, and the like which may have a significant impact on metrics like battery life and energy consumption. Temporal dynamics 424 may include data such as user behavior and device usage patterns over time, including seasonality factors, or how user behaviors and device conditions may change across different times of the day, days of the week, peak/off-peak seasons, or the like.

Synchronization data 426, according to one aspect, may include user behavior across multiple devices (e.g., cross-device) as a function of energy consumption.

According to one aspect, one or more of the system inputs 402 may be mapped to M/L models 404 particularly suited or adapted for analyzing the specific type of input data and generating meaningful outputs to be considered in the creation, implementation and maintenance of energy-saving user interaction policies. The M/L services may employ a hybrid and dynamic approach to selecting an appropriate model, ensuring adaptability and efficiency.

According to one aspect, hybrid federated models 428 may be used to analyze and process user interaction data 414. The hybrid federated models 428 may include, FedAvg and/or FedSGD models. According to one aspect, the system may dynamically switch between the two federated models based on data characteristics and model update requirements, optimizing for communication efficiency and model accuracy.

According to one aspect, energy-efficient models 430, such as a gradient boosting machine (GBM), may be used for inputs including device usage metrics 416 and environmental conditions 422.The energy-efficient models 430 may be specifically designed to predict and optimize energy consumption of carious user interface elements and content delivery mechanisms.

Model personalization techniques 432 may be used for inputs such as content preferences 418 and/or temporal dynamics, according to one aspect. Such techniques may apply meta-learning and client clustering to adapt models for performance for non-IID data in federated learning environments. This ensures models remain effective even when data distributions vary significantly across devices.

Advanced neural networks 434 may be used with inputs including user feedback 420, for example. Such models may implement specialized neural network architectures (e.g., CNNs for image data, RNNs for sequential data) to handle complex patterns more effectively. These architectures may be selected for their ability to process high-dimensional data and provide insights into user behavior and device usage.

According to one aspect, privacy preserving models 440 may be used to analyze and process personal and/or private data, including synchronization data 426. Such techniques may incorporate methods like Differential Privacy and Secure Multi-party Computation within the training process of a federated model to protect user data. These techniques ensure that the system can learn from distributed data sources without exposing sensitive information, maintaining user trust and regulatory compliance.

With these models and their varying inputs, the M/L services may generate outputs 406 directed to forming or being part of a comprehensive user interaction policy generated to promote and implement energy-saving tasks. According to one aspect, the services and outputs 406 may be implemented to provide real-time adaptation and user feedback. For example, the hybrid federated models 428 may generate energy-efficient insights 442. The output may provide users and systems with real-time predictions and insights into one or more energy consumption impact of various system and user actions. Such information may inform system decision-making to promote energy savings and reduced energy consumption.

The energy-efficient models 430 may be configured to output predictive maintenance insights 444. For example, insights may include using energy consumption and device usage metrics to predict or forecast potential hardware failures. Predictive maintenance insights 444 may also provide suggestions or predictions related to longevity optimizations.

Model personalization models 432 and privacy preserving techniques 440 may serve to output adaptive content delivery 446, according to one aspect. Such models may provide personalized content delivery plans factoring user preferences and energy efficiency. Prefetching strategies may be adjusted based on current or predicted network conditions and device statuses. According to one aspect, content delivery optimizations may further include adaptive loading, lazy loading, and eco-friendly content recommendations tailored to reduce energy usage and enhance user experience.

Feedback driven patterns 448 may be generated from advanced neural networks 434 and model personalization techniques 432. This output may utilize short-term feedback loops to adjust interaction patterns, gestures, and touch sensitivity, for example, in real-time to conserve energy without impacting the user experience.

Dynamic user interface optimization 450 output may be generated from the energy-efficient models 430. Such outputs may include real-time recommendations for user interface adjustments, including for example, dimming and/or animation reduction, based on current or predicted device usage, preferences and energy efficiency metrics.

Accordingly, as described herein, the outputs 406 may, individually and in combination, inform critical decisions regarding user interface and experience adjustments, content delivery, and device responsiveness, ensuring strategies are data-driven and effective. According to one aspect, one or more user interaction policies may be automatically generated, implemented, and updated in real-time, to apply the insights, predictions, suggestions, or the like provided by the M/L models 404 to reduce to deliver content, protect and maintain privacy and security while reducing energy consumption.

According to one or more aspects, the system may generate an energy savings report. The report may include data and other information relating to the implementation of one or more user interaction policies, user interaction data, device metrics, eco-energy system generated policies, suggestions, predictions or the like. According to one aspect, an energy savings report may be provided in one or more user interfaces.

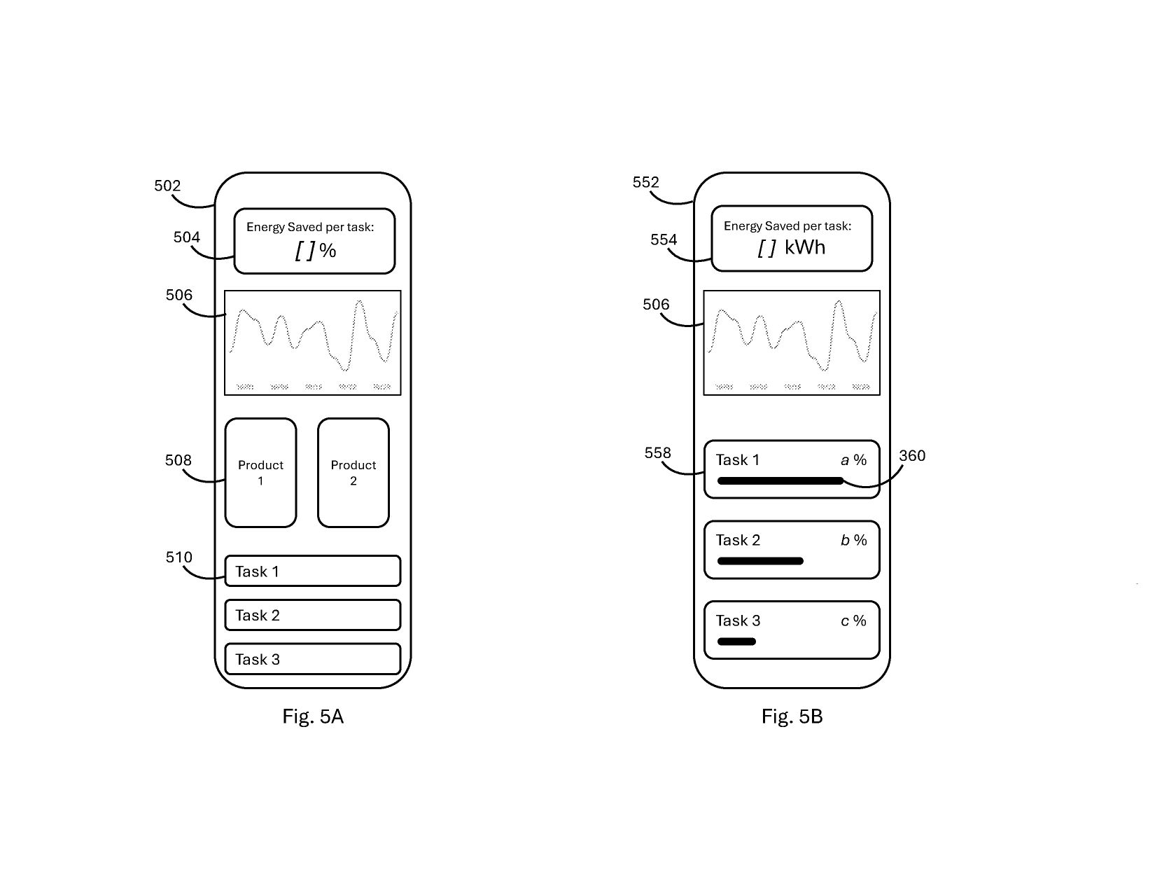

Referring now to FIGS. 5A-5B, exemplary interfaces 502, 552 featuring user-centric dashboards and user settings are provided. According to one aspect, a first exemplary interface 502 may provide a personalized energy tracker including an energy-saved indicator 504 and a time-based graph 506 providing a user with substantially immediate feedback on the user’s energy consumption, measured in kWh, for example. The graph 506, according to one aspect, may track energy consumption percentage changes over time. This feature encourages eco-friendly behavior by highlighting the energy savings achieved during the user’s online activities.

The interface 502 may further feature engagement and efficiency indicators including links or direct access to popular products 508 and one ore more functions or tasks 510, including for example, sales quote creation, order creation, product browsing, searching, exporting, or other common B2B tasks.

In an alternative interface 552, a energy-saved indicator may be presented in terms of raw energy saved, in kWh, as well as the time-based graph 506. According to one aspect, one or more tasks 558 may be presented to the user and may further include progress indicators 560 for each task not only foster user engagement by displaying task completion and/or percentage complete, but also emphasize the energy efficiency of the platform. Illustrating energy savings alongside daily tasks, the exemplary interfaces 502, 552 may deliver distinctive and practical value to users, fostering environmental responsibility and elevating the B2B online experience.

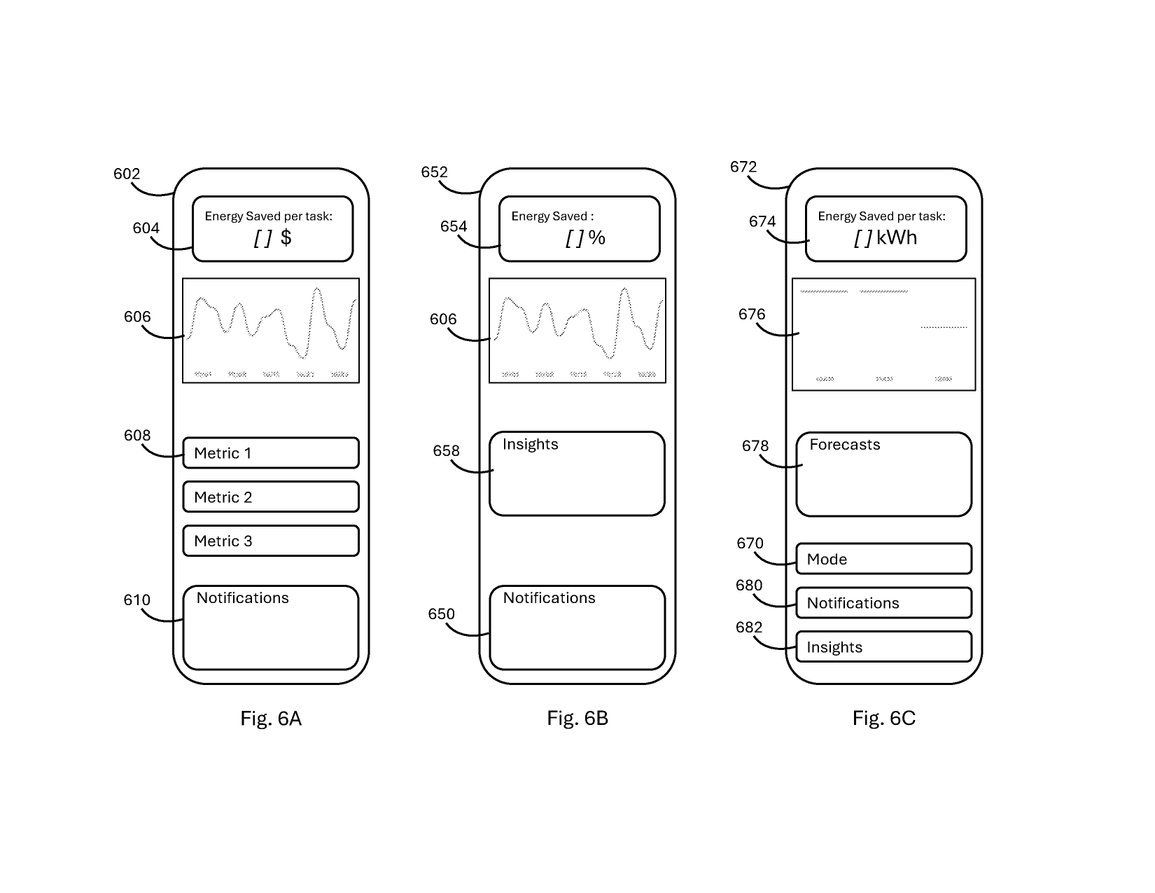

FIGS. 6A-6C depict exemplary predictive energy management interfaces 602, 652, 672 including real-time tracking and management of energy savings, according to aspects of the disclosure. Like the interfaces 502, 552, the management interfaces may include similar energy-saved indicator 604 (FIG. 6A), 654 (FIG. 6B), 674 (FIG. 6C) and a time-based graph 606 (FIGS. 6A-6B), 676 (FIG. 6C). The graph 676 may be presented as a bar graph or the like and may reflect consumption levels on an hourly basis. From the graphs and statistics presented in the interfaces 602, 652, 672 users may readily see the impact of their actions according to a number of metrics 608, including monetary terms, such as daily savings and lifetime energy saved, fostering a sense of accomplishment and awareness of cost efficiency.

According to one aspect, the interfaces 602, 652, 672 may offer personalized and tailored insights 658 (FIG. 6B) and forecasts 678 (FIG. 6C), enabling users to understand their energy consumption patterns and potential savings, which encourages continued use of energy-saving practices. Insights 658, 682 and forecasts 678 may include metrics such as, without limitation, weekly consumption rates or savings, monthly or yearly predictions of savings, or the like. The interfaces may also provide a customizable notification space 610 (FIG. 6A), 650 (FIG. 6B) in which users may personalize their experience by setting up notifications for specific energy usage scenarios, making the system proactive in aiding the user in saving energy. The notifications space may be further configured to provide optimization tips and alerts allowing the system to promote the user making informed decisions regarding their interactions aiming to reduce energy consumption and costs. According to one aspect, the interface 672 may include a number of links, including a mode link 670, a notifications link 680 and an insights link 682. The mode link may notify the user of an operational mode, such as optimized, balanced, performance, energy-saving, or the like in which predefined user settings may be applied as a profile. Activating the mode link 670 may present the user with another interface in which the user can select a different mode or modify the current mode. The notification link 680 and the insights link 682 may be activated to bring the user to a different interface in which system notifications and insights are presented in a more comprehensive manner.

One skilled in the art will recognize that the varying features of the interfaces shown and described in FIGS. 5A-6C may be separated, combined or otherwise presented (i.e., mixed and matched) without deviating from the scope of the disclosure. It will also be recognized that the individual interfaces are exemplary and may feature any combination of the features described herein.

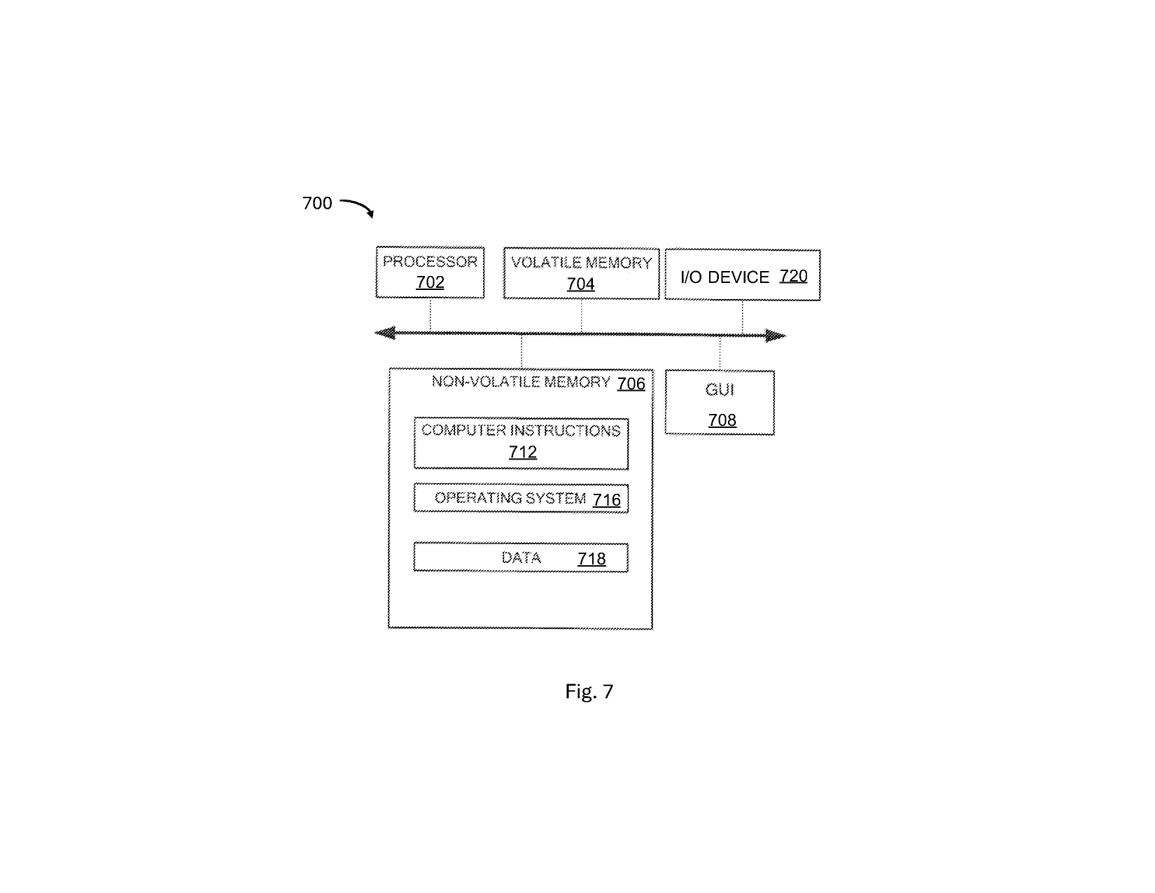

FIG. 7 is a diagram of an example of a computing device, according to aspects of the disclosure. In some embodiments, a computing device 700 may include processor 702, volatile memory 704 (e.g., RAM), non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

FIGS. 1-7 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-7 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
training a plurality of machine learning (M/L) models to predict one or more energy-saving policies using a modeling dataset comprising a plurality of training samples, each training sample generated from a corpus of historical interaction data, each training sample of the plurality of training samples to adjust weights in the plurality of M/L models, wherein training the plurality of M/L models includes inputting different portions of the modeling dataset and comparing predictions of customer actions with target values of the training samples to adjust weights in the plurality of M/L models;
receiving usage data from an application;
generating a plurality of feature vectors from the usage data;
inputting one or more of the plurality of feature vectors into one of the plurality of M/L models to predict one or more energy-saving policies; and
generating a user interaction policy based on the one or more energy-saving policies.

2. The method of claim 1 wherein the plurality of M/L models includes at least a federated learning model and an unsupervised learning model.

3. The method of claim 1 wherein the plurality of M/L models includes at least, a hybrid federated learning model, a gradient boosting machine (GBM) model, a meta-learning model, a convolutional neural network (CNN), a recurrent neural network (RNN), a Differential Privacy model, and Secure Multi-party Computation model.

4. The method of claim 1 wherein the usage data includes at least one of user interaction data, contextual data, and system data.

5. The method of claim 4 wherein the user interaction data includes at least one of device usage metrics, content preferences, and user feedback.

6. The method of claim 4 wherein the contextual data includes at least one of an environmental condition and a temporal dynamic.

7. The method of claim 4 wherein the system data includes multi-device synchronization data.

8. The method of claim 1 wherein the one or more energy-saving policies include one or more of a display and interface adjustment, a content delivery optimization, a data management and processing optimization, a device and system level optimization, a services and integration optimization.

9. The method of claim 1 further comprising generating an energy savings report and predictive alerts based on the user interaction policy.

10. A system comprising:
a memory; and
at least one processor that is operatively coupled to the memory, the at least one processor being configured to perform the operations of:
training a plurality of machine learning (M/L) models to predict one or more energy-saving policies using a modeling dataset comprising a plurality of training samples, each training sample generated from a corpus of historical interaction data, each training sample of the plurality of training samples to adjust weights in the plurality of M/L models, wherein training the plurality of M/L models includes inputting different portions of the modeling dataset and comparing predictions of customer actions with target values of the training samples to adjust weights in the plurality of M/L models;
receiving usage data from an application;
generating a plurality of feature vectors from the usage data;
inputting one or more of the plurality of feature vectors into one of the plurality of M/L models to predict one or more energy-saving policies; and
generating a user interaction policy based on the one or more energy-saving policies.

11. The system of claim 10 wherein the plurality of M/L models includes at least a federated learning model and an unsupervised learning model.

12. The system of claim 10 wherein the plurality of M/L models includes at least, a hybrid federated learning model, a gradient boosting machine (GBM) model, a meta-learning model, a convolutional neural network (CNN), a recurrent neural network (RNN), a Differential Privacy model, and Secure Multi-party Computation model.

13. The system of claim 10 wherein the usage data includes at least one of user interaction data, contextual data, and system data.

14. The system of claim 13 wherein the user interaction data includes at least one of device usage metrics, content preferences, and user feedback.

15. The system of claim 13 wherein the contextual data includes at least one of an environmental condition and a temporal dynamic.

16. The system of claim 13 wherein the system data includes multi-device synchronization data.

17. The system of claim 10 wherein the one or more energy-saving policies include one or more of a display and interface adjustment, a content delivery optimization, a data management and processing optimization, a device and system level optimization, a services and integration optimization.

18. The system of claim 10 further comprising generating an energy savings report and predictive alerts based on the user interaction policy.

19. A non-transitory computer-readable medium storing one or more processor-executable instructions, which when executed by at least one processor cause the at least one processor to perform the operations of:
training a plurality of machine learning (M/L) models to predict one or more energy-saving policies using a modeling dataset comprising a plurality of training samples, each training sample generated from a corpus of historical interaction data, each training sample of the plurality of training samples to adjust weights in the plurality of M/L models, wherein training the plurality of M/L models includes inputting different portions of the modeling dataset and comparing predictions of customer actions with target values of the training samples to adjust weights in the plurality of M/L models;
receiving usage data from an application;
generating a plurality of feature vectors from the usage data;
inputting one or more of the plurality of feature vectors into one of the plurality of M/L models to predict one or more energy-saving policies; and
generating a user interaction policy based on the one or more energy-saving policies.

20. The non-transitory computer-readable medium of claim 19 wherein the plurality of M/L models includes at least, a hybrid federated learning model, a gradient boosting machine (GBM) model, a meta-learning model, a convolutional neural network (CNN), a recurrent neural network (RNN), a Differential Privacy model, and Secure Multi-party Computation model.
